(19) United States
(12) Patent Application Publication
(10) Pub. No.: US 2026/0311545 A1
(43) Pub. Date: Oct. 8, 2026

(54) Royal 13 Casino Table Game

(71) Applicant: Jeffrey Cannon, DeSoto, TX (US)

(72) Inventor: Jeffrey Cannon, DeSoto, TX (US)

(21) Appl. No.: 19/173,084

(22) Filed: Apr. 8, 2025

(51) Int. Cl. G07F 17/32

(52) U.S. Cl. CPC G07F 17/322; G07F 17/3237; G07F 17/3258; G07F 17/3267

(57) ABSTRACT

The present invention relates to Royal 13, a casino table game based on modified blackjack mechanics with a target hand value of 13. A player is dealt one card and then decides to hit, stand, or increase their bet based on predefined rules. The dealer is dealt two cards and must hit until reaching 9 or more (including soft totals). Face cards are only worth 5. The game features a Royal 13 hand (Ace-Deuce). Players can also increase their base bet when their total is exactly 8, receiving one additional card. Optional side bets include Royal 13+ and Lucky Links (providing payouts for certain card combinations), as well as a progressive Crown Jackpot trigger. The game is designed for six-deck play but supports other deck configurations. This invention provides a dynamic, strategy-based alternative to blackjack, balancing house odds while enhancing player engagement.

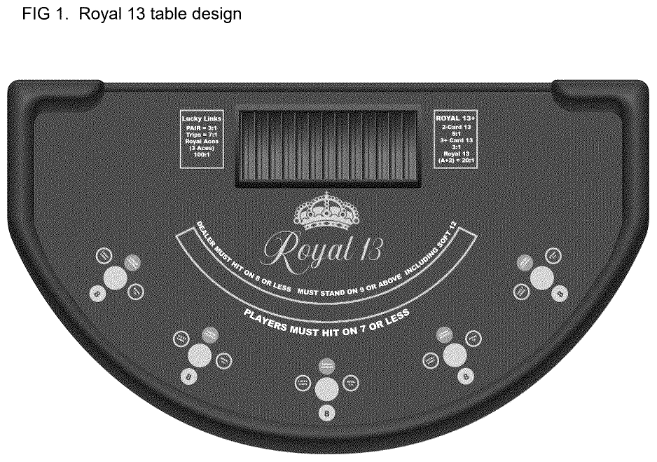

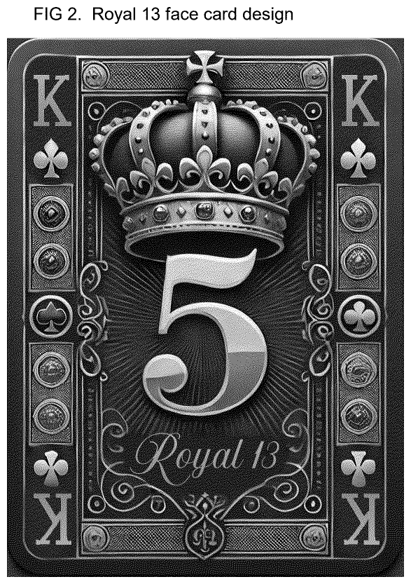

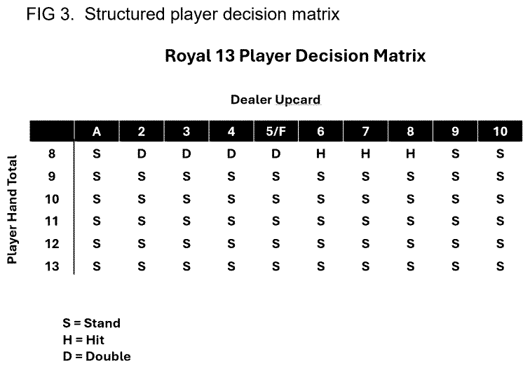

### BACKGROUND

Even with the overwhelming popularity of Blackjack in both physical and online casinos, the demand for other card-based casino games also continues to grow, as players seek variety in their casino gambling experience. Existing casino table games provide limited strategic depth while maintaining high player engagement. There remains a need for a game that combines structured decision-making with innovative side betting mechanisms. Royal 13 solves that problem by providing a unique card-based table game that utilizes mechanics similar to Blackjack yet providing a completely different gambling experience.

### DETAILED DESCRIPTION OF THE INVENTION

### 1. Game Setup

Royal 13 is a casino table game that combines strategic decision-making with a structured betting format.

The game is played on a standard casino-style table designed for up to five to six players and a dealer.

The game uses a six-deck shoe but can be adapted for single-deck or double-deck play.

Each player is dealt an initial single card, which is placed face-up. If the card is an Ace, the player is immediately dealt a second card before the next player is dealt.

The dealer receives two cards: one face-up and one face-down.

### Card Values

Face cards (J, Q, K)=5 points (instead of 10, as in blackjack).
Aces=1 or 11 points (player's choice).
Numbered cards (2-10)=Face value.

The objective is to achieve a hand closer to 13 than the dealer without exceeding 13.

### 2. Betting Structure

Each player has five betting spaces:
Main Bet—Required to play the hand, subject to table limits.
8-Bet—If a player's total reaches exactly 8, they may place an additional bet (up to their original wager) to receive one additional card and then automatically stand.
Royal 13+ (Side Bet)—Pays when the player's final total is exactly 13.
Lucky Links (Side Bet)—Pays for pairs or triplets, even if the player busts.
Crown Bet (Progressive Jackpot)—Pays if specific conditions are met (see Section 6).

Unique Rule: Even if a player loses their Main Bet, their hand continues to be played out to resolve side bets. This ensures that all Royal 13+, Lucky Links, and Crown Bet outcomes are properly determined.

### 3. Royal 13 Hand & Payouts

A Royal 13 occurs when a player's or dealer's first two cards are Ace and Deuce (A-2 or 2-A).
If a player receives a Royal 13, they are immediately paid even money on their main bet.
If a dealer receives a Royal 13, all remaining player main bets are immediately collected (excludes a player who also has a Royal 13 that was already paid).
If both the dealer and a player receive Royal 13, the Crown Bet jackpot is triggered.

### Recommended Royal 13+ Side Bet Payouts

Three or more cards totaling 13→3:1.
Two-card total of 13 (excluding A-2)→5:1.
Royal 13 (Ace-2 or 2-A)→20:1.

### 4. Dealer Rules

The dealer is dealt two cards: one face-up and one face-down.

The dealer must hit until reaching a total of 9 or more (including soft totals).

The dealer must stand once reaching 9 or higher.

If the dealer busts (exceeds 13), all remaining player main bets are paid even money.

### 5. Side Bets

### Recommended Lucky Links Side Bet Payouts

Pair (any two cards of the same rank)→3:1.
Three-of-a-kind (any three cards of the same rank)→7:1.
Royal Aces (three Aces)→100:1.

Unique Rule: Even if a player loses their Main Bet, their hand continues to be played out to resolve side bets. This ensures that all Royal 13+, Lucky Links, and Crown Bet outcomes are properly determined.

### 6. Game Flow

Players Place Bets—Players place their Main Bet and any optional side bets before the deal.

Cards Are Dealt—
Each player is dealt one face-up card (except Aces, which immediately receive a second card).
The dealer receives one face-down card and one face-up card.

Dealer Checks for Royal 13:
If the dealer's upcard is an Ace or Deuce, they peek at their downcard.
If the dealer has a Royal 13 (A-2 or 2-A), all player main bets are immediately collected unless a player also has Royal 13 (player wins).
If both the dealer and a player have Royal 13, the Crown Bet jackpot is triggered.

### Player Decisions

If the player's total is 7 or less, they must hit.
At 8, they may hit, stand, or place the 8-Bet.
At 9-13, they may hit or stand.
At 14 or more, player busts and loses immediately.

### Dealer Action

The dealer must hit until reaching 9 or more.
The dealer must stand at 9 or higher.

### Bet Resolution

If the dealer busts with a total exceeding 13, all remaining player Main Bets are paid even money.
If the dealer stands, hands are compared to determine winners.
Side bets are resolved separately.

Crown Bet Evaluation—If four face cards of the same rank (one per suit) appear on the table, the intermediate Crown Bet pays 50:1.

### 7. The Crown Bet (Progressive Jackpot Mechanism)

The Crown Bet is a progressive jackpot side bet that may be linked across multiple casino tables or locations.
Players must place a casino-determined standard bet per hand to participate.
If both a player and the dealer receive Royal 13 in the same hand, the jackpot is triggered.
The jackpot payout is split among all players who placed a Crown Bet that round on that table.
Additionally, if four face cards of the same rank (one of each suit) appear across all cards on the table, an intermediate payout of 50:1 is awarded to each participating player at the table for that round.
The jackpot progressively increases as a portion of each Crown Bet wager is contributed to the prize pool.

1. A casino table game, “Royal 13”, comprising: (a) players being dealt one initial card, with an option to receive additional cards based on predefined rules; (b) a dealer receiving two cards, one face-up and one face-down, following a structured decision matrix for hitting and standing; (c) face cards valued at 5; (d) a Royal 13 hand awarded when the first two cards in a hand consist of Ace-Deuce or Deuce-Ace; and (e) a side betting structure including a Royal 13+ bet, a Lucky Links bet, and a progressive Crown Bet, wherein the Crown Bet is triggered under specified conditions.

2. The game of claim 1, further comprising an 8-Bet feature, allowing a player to increase their bet up to their original wager if their hand total equals exactly 8, receiving one additional card.

3. The game of claim 1, further comprising optional side bets, including: (a) Royal 13+ bet: pays variable odds for achieving a hand total of 13, with a higher payout for Royal 13; and (b) a Lucky Links bet: pays based on receiving a pair or three-of-a-kind, even if the hand busts.

4. The game of claim 1, further comprising a progressive jackpot bet (Crown Bet), wherein if both a player and the dealer receive a Royal 13, the progressive jackpot is triggered and distributed among qualifying players.

5. The game of claim 1, wherein the game is played using a multi-deck shoe, with adaptable deck configurations.

6. The game of claim 1, wherein the dealer must stand on a soft total of 9 or higher.

7. The game of claim 1, wherein players receiving a Royal 13 are immediately paid before other hands resolve.

8. The game of claim 3, wherein side bet payouts are adjustable to maintain house edge percentages.

9. The game of claim 4, wherein the progressive jackpot is linked across multiple tables or locations.

10. The game of claim 4, further comprising an automated electronic tracking system to record player bets, hand outcomes, and progressive jackpot contributions.
